(19) United States
(12) Patent Application Publication
(10) Pub. No.: US 2006/0064731 A1
(43) Pub. Date: Mar. 23, 2006

(54) System and method for automated production of personalized videos on digital media of individual participants in large events

(76) Inventors: Mitch Kahle, Honolulu, HI (US); Holly Huber, Honolulu, HI (US)

Correspondence Address: LEIGHTON K. CHONG;GODBEY GRIFFITHS REISS & CHONG, 1001 BISHOP STREET, PAUAHI TOWER SUITE 2300, HONOLULU, HI, 96813, US

(21) Appl. No.: 10/945,740

(22) Filed: Sep. 20, 2004

(51) Int. Cl. H04N 7/173

(52) U.S. Cl. 725/105

(57) ABSTRACT

A system for automated production of personalized videos of individuals participating in large events employs a time synchronization method for correlating the time at which a participant wearing an ID marker is detected passing through a station at the event to the video time for the video data recorded at the station for participants passing through the station. A differential is calculated between the detection time of a reference (first) participant at the station and the video time at which the reference participant appears in the video as passing through the station. The differential is used to correlate detection times to video times in the video data for all other participants passing through the station. The system can thus automatically retrieve the video clips for any individual participant appearing at the stations of a large event, and automatically assemble them in a personalized video. The system can be applied to the stations along a long-distance race course, such as a marathon or triathlon, as well as to other environments such as parties, weddings, graduations, conferences, or even for security applications such as monitoring individuals with ID badges in large facilities or over large areas.

### TECHNICAL FIELD

This invention relates to a software method for the automated production of personalized videos on digital media for individuals participating in large events, such as marathons and other long-distance races, weddings, graduations, conferences, and the like.

### BACKGROUND OF INVENTION

Film and video have been widely used to document and replay athletic competitions, and television has been used to broadcast video of these and other events throughout the world. In the 1970s and 1980s, video tape recorders and players (VCRs) became the standard in millions of homes. From the 1990s, compact discs (CDs) and, more recently, digital video discs (DVDs) have replaced videotape as the new standard in storage and delivery media for high quality audio and video.

Simultaneously over the past 30 years, there has been an explosion of interest in physical fitness, and running, jogging, biking, and swimming have become popular recreational activities. As this interest has grown, large-scale long-distance races, such as marathons, bicycle races, and triathlons have been organized in major cities throughout the United States and the world. Today millions of people routinely participate in these events. Many train year-round in order to participate in the largest and most prestigious events, such as the Boston Marathon and the Ironman Triathlon World Championship.

Competing in a marathon or triathlon can be a life-transforming experience, an achievement worth commemorating. Photography has long been the most common means of memorializing these athletic endeavors. A photo of a participant crossing the finish line has served as both memory and proof of accomplishment. Still photographs, however, do not match the thrill and excitement of watching an event unfold on video. Video can capture the sights, sounds, and emotions of real-life experiences like no other medium. The desire to share the experience with friends and family is natural, but because such endurance events are spread over such a wide area—the marathon course is 26.2 miles long—it is almost impossible for spectators or photographers to catch more than a brief glimpse of any individual participant.

In 1994 a new electronic timing system was developed which allows individuals to be tracked at long-distance events as they traverse along the course. Radio frequency transponder chips, encoded with unique identification numbers, are attached to the shoe or ankle of each participant. The chip is used to identify each participant when they cross various timing points (over chip detector mats) placed along the event course. Whenever a chip is detected, the system records the exact time in a computer database. Today almost all major marathons and triathlons use these electronic timing systems to record official event results.

Still photographs are a standard, relatively low-cost method of commemoration used at most marathons, triathlons, and other events. Typically, all participants are photographed at one or two stations along the course and at the finish line, and later identified by their race bib number. Photo proofs are then mailed to the participants for selection and purchase. Still photographs, however, are unable to capture the movement, sound and emotion of an event as video can. Highlights videos, delivered on both VHS videotape and DVD discs, have recently been offered at major marathons and triathlons. In some cases these highlights videos have been “personalized” by manually adding short individual video clips of a participant shot on video at the start or end of the race. However, this process provides only minimal personalization, and is very labor-intensive and costly to produce.

In other types of events, personalized recordings of individual participants in large events have typically been made by manual videography and manual editing and post-production. Wedding, anniversary, and graduation videos have long been recorded by amateurs and professionals to create personalized videos. Recreational activity companies frequently provide personalized videos for participants in scuba diving, tandem skydiving, parasailing, rafting, and other vacation activities. Such manual videography and editing is labor-intensive and time-consuming and costly to produce.

Some systems have thus been developed to partially or wholly automate the process of producing personalized videos of participants in large events. For example, U.S. Pat. No. 5,576,838, issued Nov. 19, 1996, and U.S. Pat. No. 5,655,053, issued Aug. 5, 1997, to Richard L. Renie disclose a “personalized, full-motion, video-capture system” promoted as “the natural evolution of theme park photographic souvenirs.” The Renie system employs bar code readers at different amusement ride stations that are swiped with the user's ID number on a card to identify the subject(s) to pre-positioned digital video cameras that are activated to record the subject(s) as they board the ride or exit from the ride station, then the video segments marked with a particular user's ID number are retrieved from the system database and automatically assembled on videotape to create a personalized video of that person's day at the amusement park. However, such prior systems do not have the capacity to shoot scenes with large numbers of participants passing through stations along a course on continuously running video, and automatically retrieve the video clips in which an individual participant appears for assembly into a personalized video.

### SUMMARY OF INVENTION

It is therefore a principal object of the present invention to provide a system for automated production of personalized videos for individuals participating in large events. It is a particular object of the invention to provide a system having the capacity to shoot scenes with large numbers of participants passing through stations along a course on continuously running video, and automatically retrieve the video clips in which an individual participant appears, and assemble them in a personalized video. It is a specific object to provide a technique for time synchronization of the clock time at which a participant is detected passing a station to the video time for the camera video recorded at each station passed by the participant, so the video clips of the participant taken at each station can be automatically retrieved.

In accordance with the present invention, a system for automated production of personalized videos for individuals participating in a large event comprises:
(a) a plurality of participant ID markers each borne or worn by a respective one of a corresponding plurality of participants in a large event for uniquely identifying each participant in the large event;
(b) a plurality of stations distributed in a physical space encompassed by the large event, wherein each station has a detector for detecting the presence of ID markers on participants passing through the station and providing detection time data corresponding to the detection time at which each participant is detected as passing through the station, and at least one digital video camera positioned at the station for continuously recording video of participants passing through the station, wherein the video is recorded as video data indexed with video time denoted by a sequential video time code;
(c) a system database for storing the detection time data for the participants detected passing through the stations at the large event, and the video data continuously recorded by the digital video cameras positioned at the stations at the large event;
(d) a time synchronization module operable with said system database for correlating the detection time for each participant passing through each station with video clips corresponding to the video time of the video data recorded by each digital video camera corresponding to that participant passing through that station; and
(e) a video production module operable with said system database and said time synchronization module and having means for: (i) identifying the video clips of an individual participant passing through the stations at the large event based upon the detection times of that participant's marker ID at the stations, and (ii) assembling the video clips for the individual participant in a personalized video.

As a specific feature of the invention, a time synchronization step is carried out to correlate the point in time in the video when each participant passes the timing point of a station (e.g., crosses the timing detection mat on a marathon course) by detecting the clock time when a reference participant passes through the station, identifying the video time when that participant appears in the video as passing through the station, and calculating the differential between the detection time and the video time for the reference participant. Typically, the reference participant can be the first participant (first runner) to pass through the station. The differential is then used to adjust the clock times of detection of the other participants passing through the station to the video time at which those participants appear in the video as passing through the station. In this manner, once the differential has been calculated for the reference participant, the exact point for each video clip in the video in which each other participant appears in the station can be automatically identified from the video time code, then assembled with other video clips for that participant at the other stations into a personalized video for the event as a whole.

This invention advantageously automates the personalized video production process, enabling a single operator to produce hundreds or thousands of personalized videos for the event. The personalized videos are preferably recorded on large-capacity DVD discs to provide 30 minutes to an hour or more of video. By improving the speed, efficiency, and productivity with which personalized DVD videos are manufactured, and by almost eliminating the cost of manual editing, and production, this invention makes personalized DVD videos competitive with the cost scale of still photographs. By adding other content obtained for the event, such as standard event assets, sponsor IDs, personal messages, music and narration, the personalized videos can obtain a new level of emotion and viewer response, as if reliving the experience of running a marathon or triathlon. Because of the nature of digital data, the standard event assets (i.e., non-personalized, highlights audio/video sequences of the program) are virtually the same on very DVD manufactured for a given event. Only the personalized video clips and graphics are changed. This assures the integrity of the data and can greatly reduce the time required to process each DVD. Instead of having to encode and multiplex each DVD in its entirety, the system can encode and multiplex only the content that changes with each participant in the process of adding the personalized video clips and graphic menus. Quality control requirements are also reduced, since only personal clips need to be verified by quickly scanning the tracks of each finished DVD. The system provides substantial savings of both time and cost, and virtually eliminates customer complaints or returns due to errors associated with having to completely encode and multiplex the full data for every DVD.

Other objects, features, and advantages of the present invention will be explained in the following detailed description of the invention having reference to the appended drawings.

### BRIEF DESCRIPTION OF DRAWINGS

FIG. 1 illustrates video equipment for a station at a large event used in the system for production of personalized videos.

FIG. 2 illustrates installation of the digital video camera equipment on an event course.

FIG. 3 is a flowchart of a preferred video capture process.

FIG. 4 is a flowchart of a preferred sequence for video processing.

FIG. 5 is a flowchart of a preferred video timing data processing.

FIGS. 6A and 6B constitute a flowchart of a preferred process for synchronizing video data with timing data.

FIG. 7 is a flowchart of a preferred processing of personal messages on the video.

FIGS. 8A, 8B, 8C, and 8D constitute a flowchart of operations for making a personalized DVD.

FIG. 9 is a flowchart for creation of the initial DVD Project.

FIG. 10 is a diagram illustrating the content and procedures for playback of a DVD produced by the system of the present invention.

FIG. 11 illustrates the array of equipment used in DVD production.

### DETAILED DESCRIPTION OF INVENTION

An example of a preferred embodiment of the system of the present invention is described below for the production of personalized videos for a long-distance race event such as a marathon, referred to herein as “MyMarathonDVD”. However, it is to be understood that the principles of the invention disclosed herein are not limited to this particular example, form of implementation, or type of event application. The principles of this invention have wide applicability to any equivalent systems, comparable forms of implementation, and other types of large events, including weddings, graduations, conferences, and even for security applications such as monitoring the movements of individuals through large facilities or over large areas. All such systems, implementations, and event applications are considered to be within the scope of the present invention.

In this example, the preferred storage and playback medium is the DVD disc, however other types of recording media, such as CDs, memory stick, memory card, flash memory, online downloads, online streaming video, broadcast video transmission, wireless video transmission, etc., are not precluded. DVDs can store 7-10 times the capacity of CDs, and take up much less volume and provide random access for playback as compared to videotape. In terms of quality, DVD provides 480 lines of resolution and is a non-degradable digital format; whereas VHS tape provides only 240 lines of resolution and is analog tape, which degrades considerably over time and with repeated use. DVDs are also capable of reproducing CD-quality audio, whereas VHS tape has very limited audio reproductive capability. DVDs are in digital format that supports multimedia, providing users with greater flexibility and control. For example, it can record different media formats, and provide the ability to use menus, or to select scenes, and other options for viewing.

The MyMarathonDVD system is designed as an automated system for producing and manufacturing personalized DVD-videos for participants in sporting events and athletic competitions, with initial application specifically designed for contestants in marathons and triathlons. The system takes advantage of the type of ID timing chip embedded with a miniature radio frequency transponder that is encoded to transmit a unique identification number for participants at these types of sporting events. Chip detector mats are placed at various locations on the marathon or triathlon course. Each time a participant crosses one of these detector mats, the chip transmits a signal containing the participant's unique identification number, which is in turn recorded and logged into a computer database with the corresponding time. Upon successful completion of the event, an official event data file(s) is obtained from the event's timing service. This file includes a record of the exact times, relative to the official event clock, when each participant passed over the various detector mats on the course. Typically for marathons, participant times are recorded at the start, 10 kilometers, half (13.1 miles), 30 kilometers, and the finish line. Additional course points (e.g., 15 k, 20-miles, 40 k) are sometimes included. As the use of these ID chips and detector mats for event timing are well known in the industry, the specifics of their operation are not described in further detail herein.

The MyMarathonDVD system also employs commonly available digital video cameras (“DVCAMs”) connected to digital video recorders (“DVRs”) and video hard drives (“VHDs”) to continuously record all participants as they approach, pass over, and depart the course timing points where the detector mats have been placed. Depending upon the camera angle and focal length of the lens, participants can appear in the video field of view at each location from 20 to 60 seconds. Digital video files from each camera are backed up and stored on the individual hard drives. Each video file is recorded with a continuous sequential time code. For example, most DVRs use a SMPTE time code that is synchronized to a clock timer for the device. The SMPTE time code allows each frame of the recorded video to be identified with a time index code, which is used for synchronization of recording and playback. These DVRs and VHDs are well known in the industry, and the operations thereof are not described in further detail herein.

In the system of the present invention, a timing synchronization subsystem correlates the time positions of the chip detection signals of participants as they cross the detection mat with the sequence of timing code signals from the digital video camera at that timing point, so that the time position of each detected participant ID code is demarcated with the time indexing of the video image frames at that time position. In effect, the video time code from each video file is synchronized with the corresponding participant timing data logged by the detector mats. In this manner, the video segments for each participant can be retrieved automatically in a time sequence for production of the personalized DVD video. The system can be utilized even if the participant appears randomly or in any sequence at the event stations.

A DVD production subsystem can produce a unique DVD product for each participant automatically. A software program automatically locates and copies the video clips that include the individual participant detected as passing through each timing point on the course. The software processes the copied raw video clip files by superimposing subtitle text tracks (name, bib number, location, and time) and compressing/encoding the individual files in a DVD-video standard format. The software also separately processes custom titles and results data (for each participant) by adding text layers to pre-formatted graphics files to create personalized DVD menus. These personalized video and graphics files are automatically inserted into tracks of a DVD project file and combined with corresponding standard video and audio files which combine overall event highlights video with narration, music, and natural sound. Each DVD track corresponds with a precise temporal location within the program sequence. The DVD tracks are activated via standardized program, menu, and/or remote control buttons. Preprocessed standard tracks (which appear unchanged on all DVDs) include post-production audio, event highlights video, graphics, and menus, that make up the DVD-video program, which averages from 25 to 30 minutes in total running time. The combined and personalized DVD file is multiplexed (i.e., encoded for compliance with DVD-video standards) and burned (i.e., formatted, written, and finished) to a DVD-R disc or other media. The finished DVD-video disc is custom imprinted with the individual participant's name, bib number, and finish time along with the event title, logo and date. The completed DVD-video is quickly scanned for quality control and then packaged in a standard book-style case with a preprinted cover.

The operational details for a preferred example of the MyMarathonDVD system are now described in further detail below.

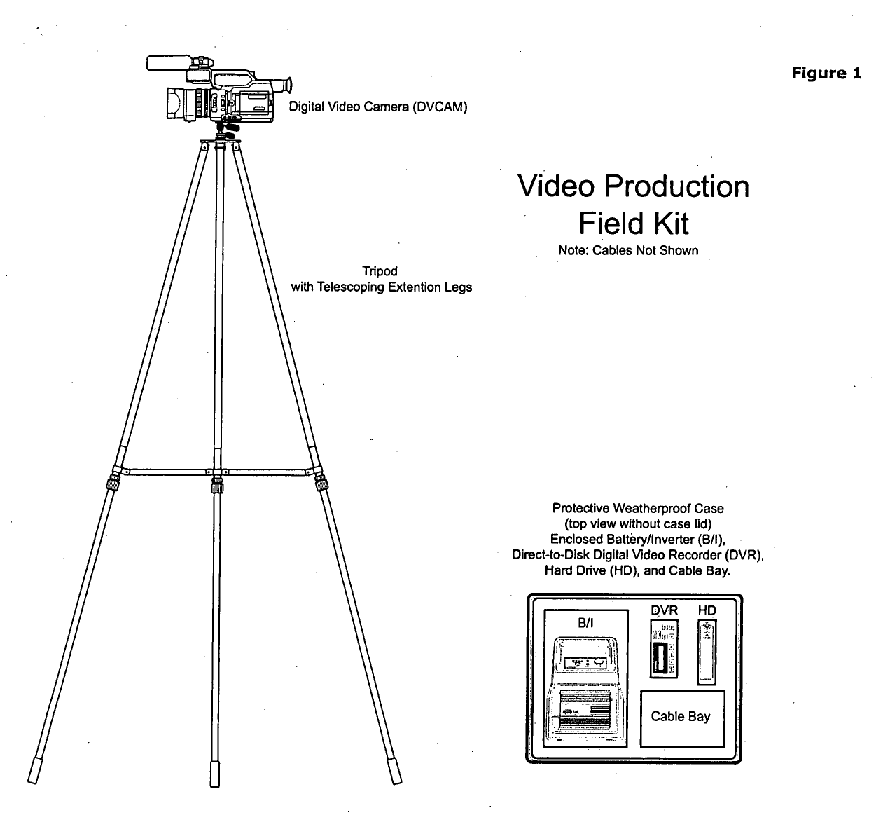

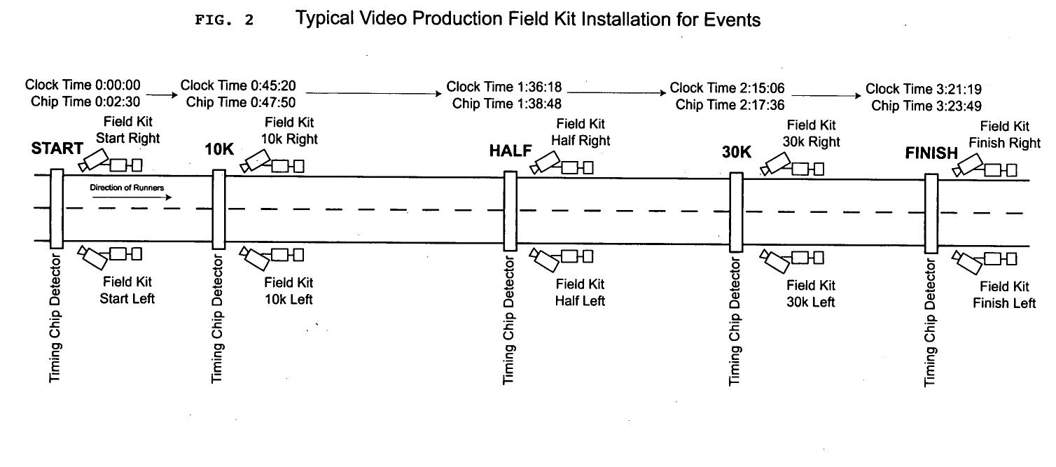

Event Video Capture. Referring to FIG. 1, a number of stations are defined along the event course, and a DVR kit is installed at each timing point. The DVR “field kit” includes a DVCAM camera, a direct-to-disk digital video recorder (“DVR”), a video hard drive (“VHD”), batteries, inverter, tripod, and protective weatherproof case. To produce raw digital video for an event, multiple field kits are set up at selected course timing points (e.g., Start, 10 k, Half, 30 k, Finish), usually one field kit on each side of the course, positioned to face oncoming participants approximately 50 to 100 feet beyond the chip detector mats, as illustrated in FIG. 2. The DVCAMs are placed on the tripods and adjusted to heights of 8 to 12 feet using telescoping extension legs. The DVCAMs' angle, framing, and lens focal length are optimized and then locked into position to record all event participants as they approach and pass through the timing point.

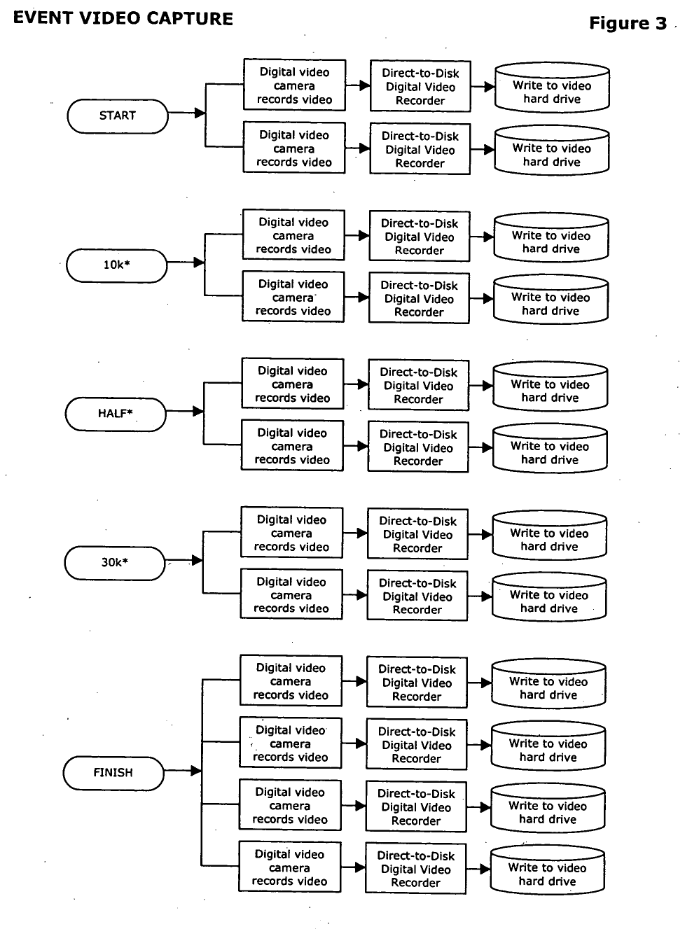

Once the field kit systems are turned on, digital video is transmitted from the DVCAMs to the DVRs, which continuously write data files that are stored on the VHDs, as illustrated in FIG. 3. This is known as direct-to-disk digital video recording. After the last participant has finished (or the event at the given timing point is deemed over), the field kits are turned off and disassembled. The VHDs, which contain all of the stored digital video files, are packed in protective, shock-resistant cases for immediate transport to a DVD production facility. The digital video data on each VHD is copied to newly reformatted VHDs to create a complete set of duplicate back-up VHDs.

In conjunction with the video produced by the field kits (as described above), a team of professional cameramen is dispatched and directed to shoot the overall highlights of the event. This highlights video is used in post-production to create, write, and edit the common elements of a complete event video program. Typically 20-25 minutes long, this program—including scripted narration, original music, natural sound, animation, and graphics—tells the story of the event from start to finish. For example, the complete highlights program may be divided into sequences, as follows: Introduction; Pre Event-Start; Start-10 k; 10 k-Half; Half-30 k; 30 k-Finish; Post Event or Conclusion. The highlights segments are used (in the course of the overall program) to establish the context for the individual or personalized video clips recorded by the field kits. In addition, participants may have the opportunity to record a free personal video message before the event at the expo or after the event in the finish area. This video data is also obtained using a field kit with direct-to-disk digital video recording. The personal messages are optional and specific to a participant or participants. Personal messages are recorded with or without the participant, often with friends or family.

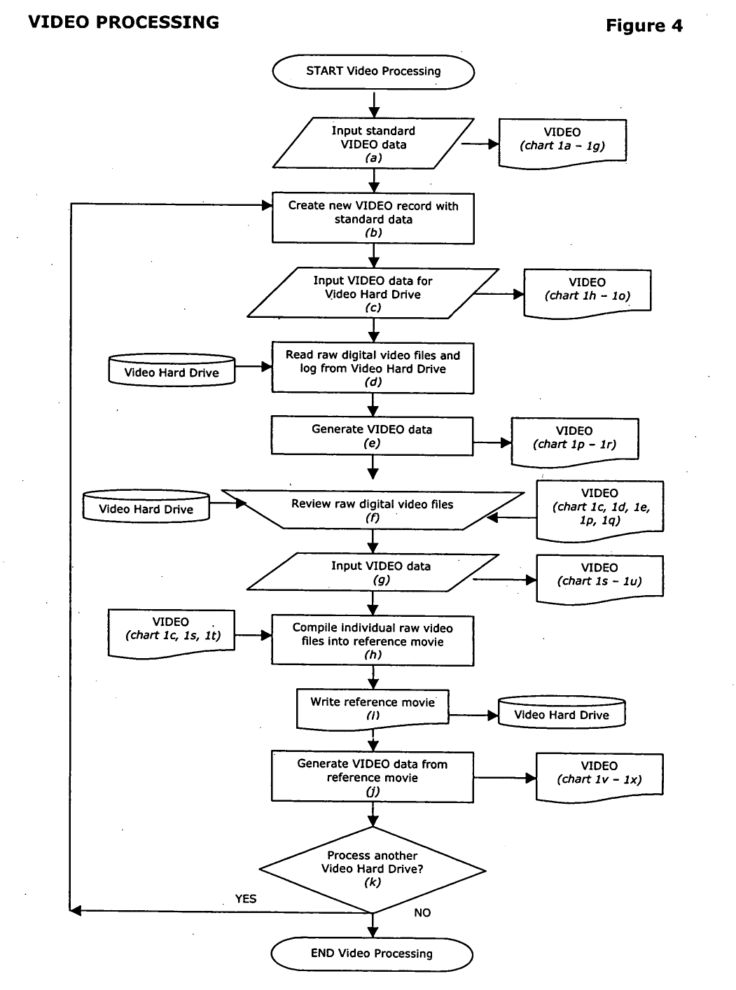

Video Processing. Once all of the video data has been acquired and copied (for back-up), preparation and set up for DVD production can begin. This complex process is detailed in FIGS. 4-7 and appended Charts 1-4. Each VHD is attached to a server and identified according to its location at the specific course timing point (e.g., 10 k-right, 30 k-left) where the digital video was obtained. A Video Record is initialized and created for each VHD's video data, as shown in Steps 4(a)-4(g) in FIG. 4. The contents of each VHD are cataloged in the VIDEO database using the parameters shown in Chart 1, which detail the information regarding the event, the equipment, and the raw digital video files (Chart 1, Items 1a-1r). The raw digital video files are reviewed to determine which files should be included in the “reference movie” (see Chart 1, Items 1s-1u). The contents of each VHD are then compiled into the reference movie for that timing point, as shown in Step 4(h). The related raw digital video files are combined into a single reference movie which details the sequential order, start and end times of all video files contained on the VHDs into the VIDEO database, as indicated in Steps 4(i)-4(j), and Chart 1, Items 1v-1x. Thus each VHD connected to the server represents a specific timing point location where digital video was continuously recorded throughout the duration of the event. When the VHD contents are compiled into the reference movie, the processing program then checks whether to process a next VHD, as shown in Step 4(k). If NO, then the Video Processing ends. The reference movies for each of the specific course timing points are then synchronized with the official event timing data obtained when each participant passed over the detector mats on the course (described further below in Synchronization).

Official Event Data. Official event data are provided by the event and/or the timing company. The official data is comprised of both entrant data (see Chart 2, Items 2b-2p) and timing data (Chart 3, Items 3b-3c). Official event data includes details regarding each participant such as bib number, name, address, age, gender, division, placements, and official times. The data may be provided as a single file or as multiple files. Events assign a unique number to each participant. This bib number is so-called because it is usually printed on a paper placard and worn on the participant's chest. The bib number is used universally by events, timing companies, photographers, and spectators to identify participants. However a bib is not technically necessary; any unique identifier will do.

Event Timing. The event clock time is not the chronological AM or PM time, but is an elapsed time beginning at zero (the official start of the event) and continuing without pause or interruption until the event has concluded. Event timing is usually hours, minutes and seconds (hh:mm:ss). The finish clock time for a participant is the elapsed time from the official start of the event to the time when a participant's timing chip comes in contact with the finish timing mat. For example, a participant who crosses the finish line at 4:15:30 PM in an event that started at Noon, would have a finish clock time of 4:15:30.

An event measured only by the finish clock time assumes that all participants started the event at the exact same time. However in large events with thousands of contestants, it may take a participant in the back of the pack as long as 30 minutes to pass the timing mat at the official start of an event. In such cases, the participant's elapsed time may be measured by the difference between the start chip time and the finish chip time. The start chip time is recorded by a timing chip at the official starting line of an event. For example, a participant who crosses the starting line at 12:09:45 PM in an event that started at Noon, would have a start chip time of 0:09:45. The finish chip time is the finish time when the participant's timing chip comes in contact with the finish timing mat adjusted by subtracting the individual's start chip time. Using our previous example of a participant with a finish clock time of 4:15:30 and a start chip time of 0:09:45, the official finish chip time would be 4:05:45. In other words, the elapsed time it took for the participant to cover the entire course from starting line to finish line is recorded as the finish chip time (e.g., 4:05:45), whereas the elapsed time from the official start of the event (also known as gun time) until the participant reached the finish line is the finish clock time (e.g., 4:15:30). A participant that crossed the starting line at the exact start of the event would have a start chip time of 0:00:00 and thus their finish clock time and finish chip time would be concurrent. Chip time and clock time for every timing point filmed are necessary for generating accurate video clips. This chip time verses clock time distinction is a factor used in the automatic location and extraction of individual video clips from the hours of raw unedited digital video (described further below in Synchronization).

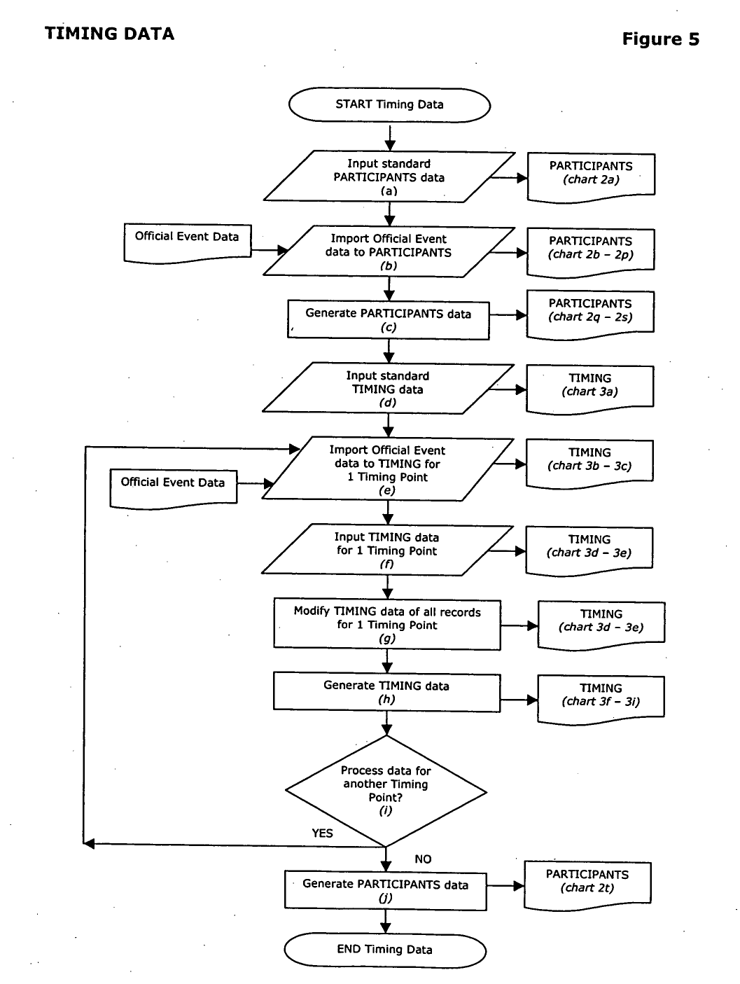

Event Data Preparation. The official event data varies in form and format depending on each event, often requiring extensive processing to formulate the data in standard fields and formats. The importation, integration and computations for entrant and timing data required for the DVD manufacturing process are detailed in FIG. 5 and appended Charts 2-3. In Steps 5(a)-5(b), the standard PARTICIPANTS data are input, and the official entry data are imported into the PARTICIPANTS database, with one record for each event entrant (Chart 2, Items 2b-2p). After importing official event data into the PARTICIPANTS database, computations are made in Step 5(c) to determine each PARTICIPANTS finisher status and to format data for use on the personalized DVDs (Chart 2, Items 2q-2s).

In Steps 5(d)-5(e), standard timing data are input, and official event data are imported into a separate TIMING database (Chart 3), with a record for each timing point for each participant. Only the bib number and chip time (Chart 3, Items 3b-3c) need to be imported in the TIMING database. In Steps 5(f)-5(g), TIMING data for 1 timing point are entered to correspond with the VIDEO data for that timing point and to modify the TIMING data for all records for the 1 timing point (Chart 1, Items 1n-1o, Chart 3, Items 3d-3e). In Step 5(h), other TIMING data are generated there from, such as count of video files, clock time, and actual order (Chart 3, Items 3f-3i), then the program routine returns in Step 5(i) to process data for another timing point. When the data for all timing points are processed, the remaining PARTICIPANTS data are generated in Step 50(j) (Chart 2, Item 2t).

Some timing data are imported into both PARTICIPANTS and TIMING databases. Since the finish clock time (Chart 2, Item 2n) and finish chip time (Chart 2, Item 2o) appear on DVD subtitling and personalized menus, it is included in PARTICIPANTS as well as TIMING databases. Start chip time (Chart 2, item 2p) is used to calculate clock times (Chart 3, Item 3g) for other timing points so it is also included in both databases.

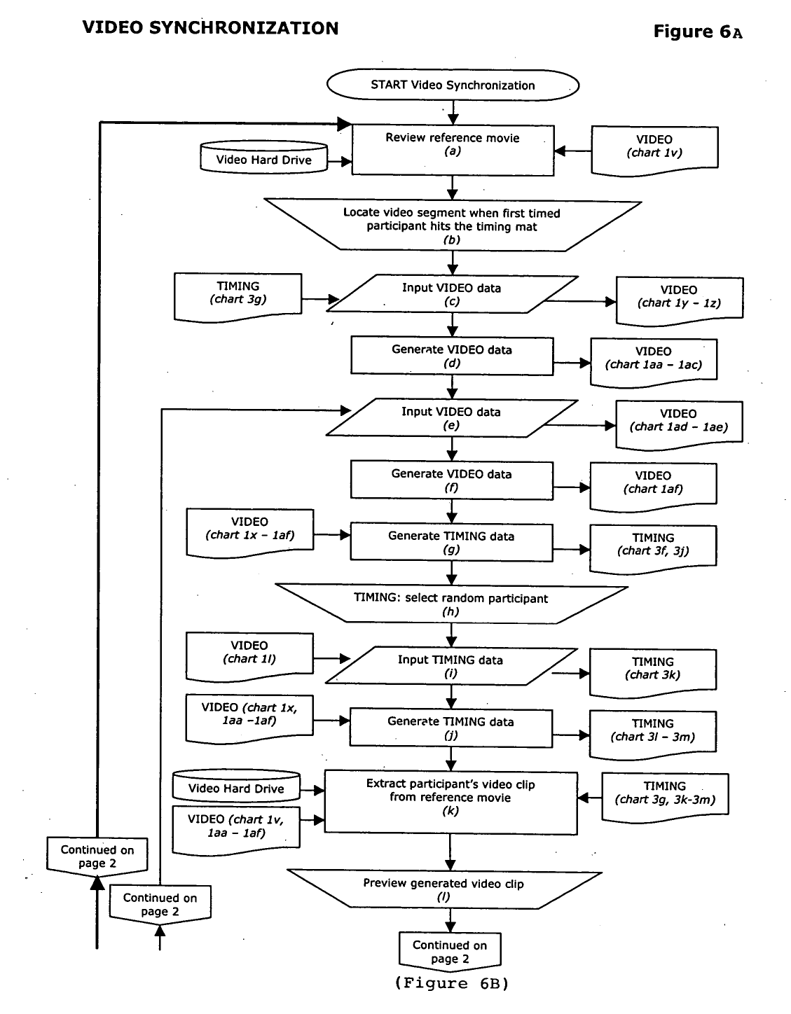

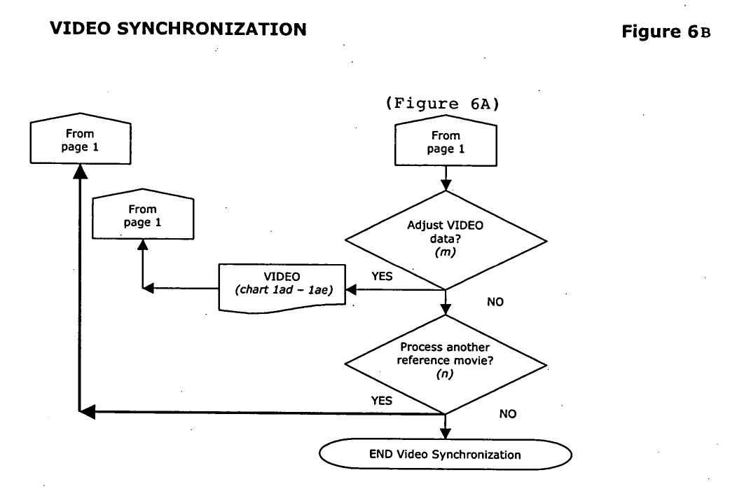

Synchronization. Having explained the important distinctions between chip time and clock time, there is yet another crucial time component to include in the process: digital video time code. Since the clock time represents the exact time recorded when participants are detected crossing a given timing mat, this time can be synchronized with the digital video time code to establish the exact time position in the video when any given participant will appear in the scene. Thus, before DVD production can begin, each reference movie file must be synchronized with the official event timing data. This complex process is detailed in FIGS. 6A-6B. Synchronization is accomplished by noting the exact time in the video when the first timed participant appears as crossing the timing mat at that point, as indicated in Steps 6(a)-6(b). The first participant's clock time at that timing point is then used to calculate a specific duration representing the difference between the video time code and the event clock time, as indicated in Steps 6(c)-6(d). Because all participants start the event with the same clock time and all participants record a start chip time (when each crosses the starting line timing detector mat), the video time code is easily synchronized for all participants by calculating the differential (Chart 1, Item 1aa).

For example, in an event that begins at Noon, the professional participants begin the event directly on the starting line, and thus each records a start chip time (00:00:00) that is concurrent with the start clock time (Noon). Although technically any participant could be used to synchronize the video, the fastest ones in the front are easiest to use since their clock times and chip times are always concurrent and because they are easy to identify visually in the video. Continuing with this example, suppose the field kit camera at the 10 k timing point was turned on 10 minutes and 30 seconds before the first participant arrived and crossed the timing detector mat. Further suppose that the first participant's chip time recorded is 00:32:10. Thus the video time code would read 00:10:30 for the first participant's clock time of 00:32:10. To synchronize the video time with the clock time, the differential (Chart 1, Item 1aa) is calculated by subtracting the clock time (Chart 1, Item 1z) from the video time (Chart 1, Item 1y) when the first timed participant crossed the timing detector mat. In this example, the differential time would be minus 00:21:40. This differential time is then used to synchronize the clock times of all other participants (XX) with the video time code recorded at a given timing point.

For any timing point:
VIDEO TIME(REF)−CLOCK TIME(REF)=DIFFERENTIAL
CLOCK TIME(XX)+DIFFERENTIAL=VIDEO TIME(XX)

A separate differential time must be calculated for each video reference movie recorded by the various field kit camera systems. A separate differential is required because each camera is set-up and turned on (begins recording) at different times. In addition, the beginning and end times of each reference movie (Chart ₁, Items 1ab-1ac) are computed, in Steps 6(c)-6(d). This important data is later used to determine the whether a participant's video clip is contained within the reference movie.

Video Clip Length and Offset. In addition to synchronizing timing data with video time code, each video must be reviewed to determine the optimum video clip length and offset to show a participant detected as crossing the mat at each timing point. The desired clip length (Chart 1, Item 1ad) is determined by selecting an average time duration in which the typical individual appears in a scene (usually 20 to 30 seconds). The clip offset (Chart 1, Item 1ae) is the time duration in which an individual is visible in the scene before crossing the timing detector mat. For example, in a 30-second video clip, a typical offset would be 20, making the video clip begin 20 seconds before the participant's clock time and end 10 seconds after. To determine the optimal clip length and offset periods for typical participants in the event, testing may be done with various random participants in each reference movie to generate sample video clips for review, as indicated in Step 6(e)-6(m). The clip offset and clip length may vary from camera to camera, depending mostly on the angle and focal point of the particular scene, and therefore is processed for each reference movie, as indicated in Step 6(n).

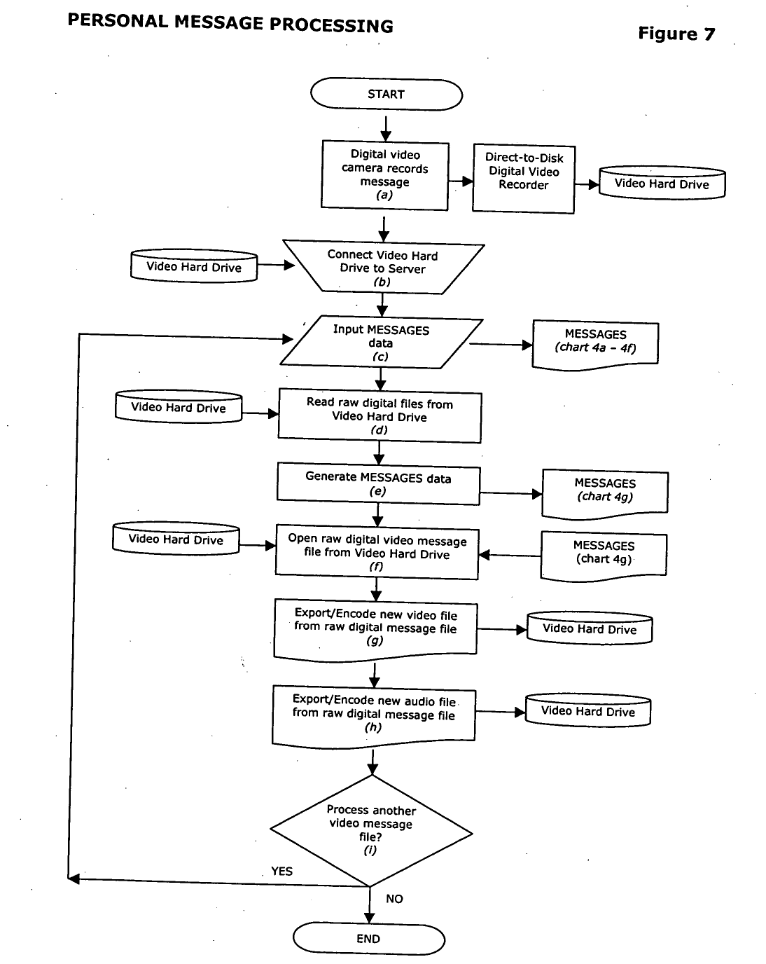

Personal Message Processing. A personal video message may be input and processed to ensure that a personalized video message is included on that individual's DVD. Referring to FIG. 7, a digital video camera at a given location (before the event at the expo or after the event in the finish area) records each individual's message in Step 7(a), and stored on the accompanying VHD with direct-to-disk digital video recording, from which the raw video message files are connected to the system server, in Step 7(b). In Steps 7(c)-7(h), the MESSAGES database (Chart 4) catalogs the personal video messages that were recorded by participants with one record for each video message. The date, bib number and name (Chart 4, Items 4a, 4c) are documented at the time the message is recorded. The MessageNo, a unique file number generated by the DVR, is also noted (Chart 4, Item 4d). A unique code linking each message to the appropriate participant is entered in MESSAGES database (Chart 4, Item 4b). Once the data is input, each raw video message file from the VHD is read and automatically encoded with a separate audio and video file named using the unique message code, in Steps 7(c)-7(h), then the next video message file is processed, in Step 7(i). These encoded message files are later used in the DVD manufacturing process.

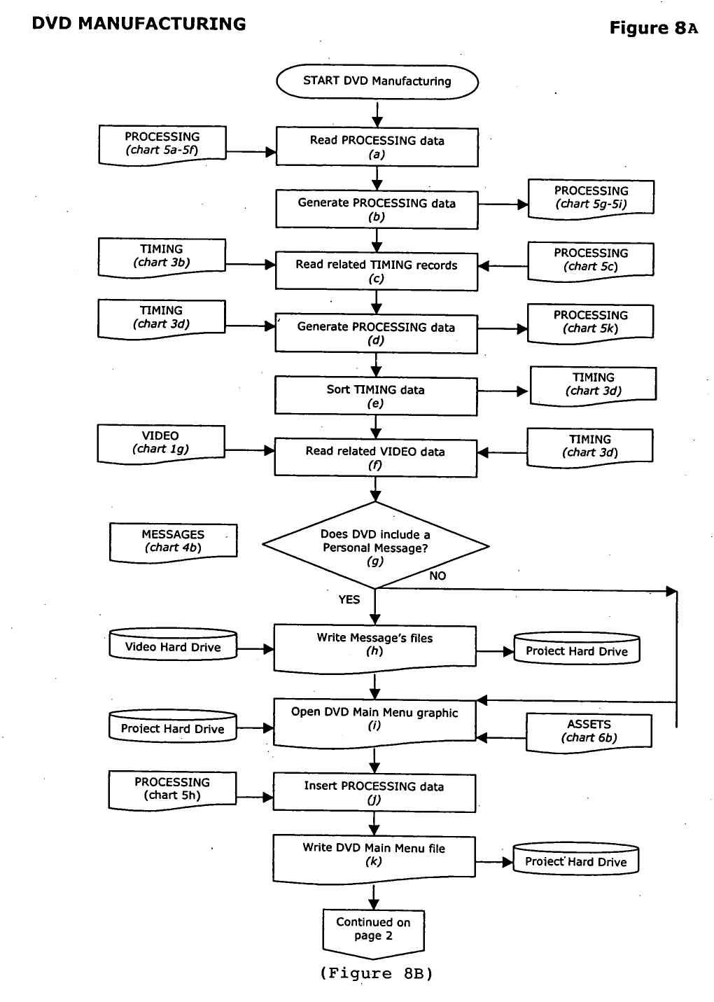

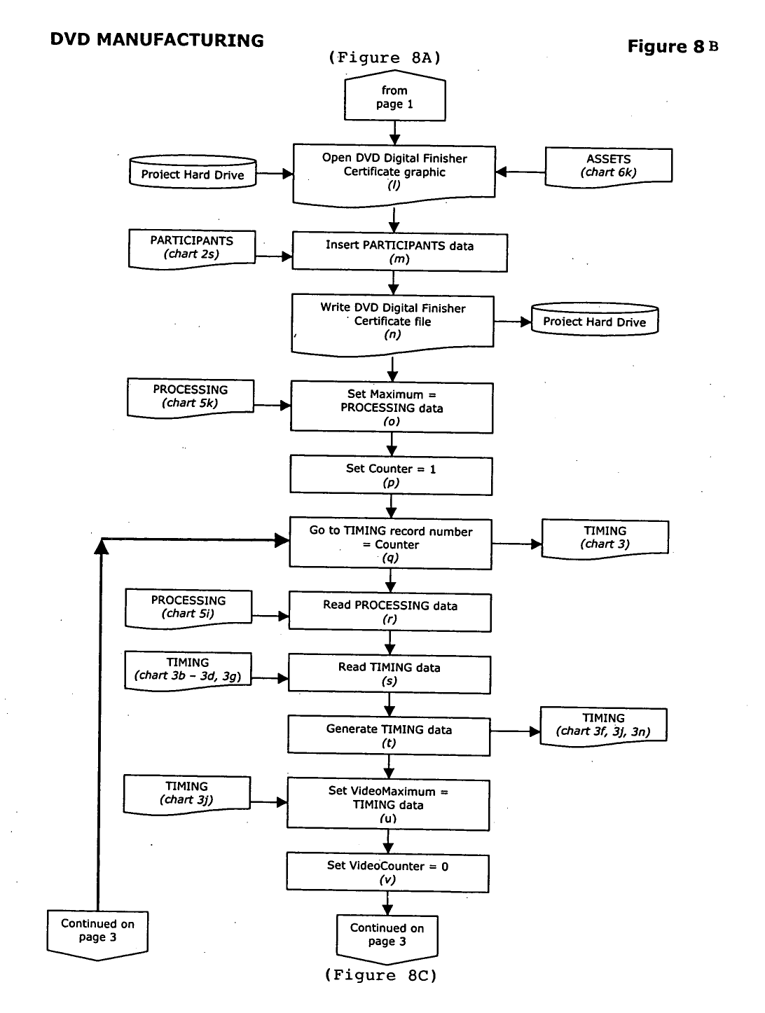

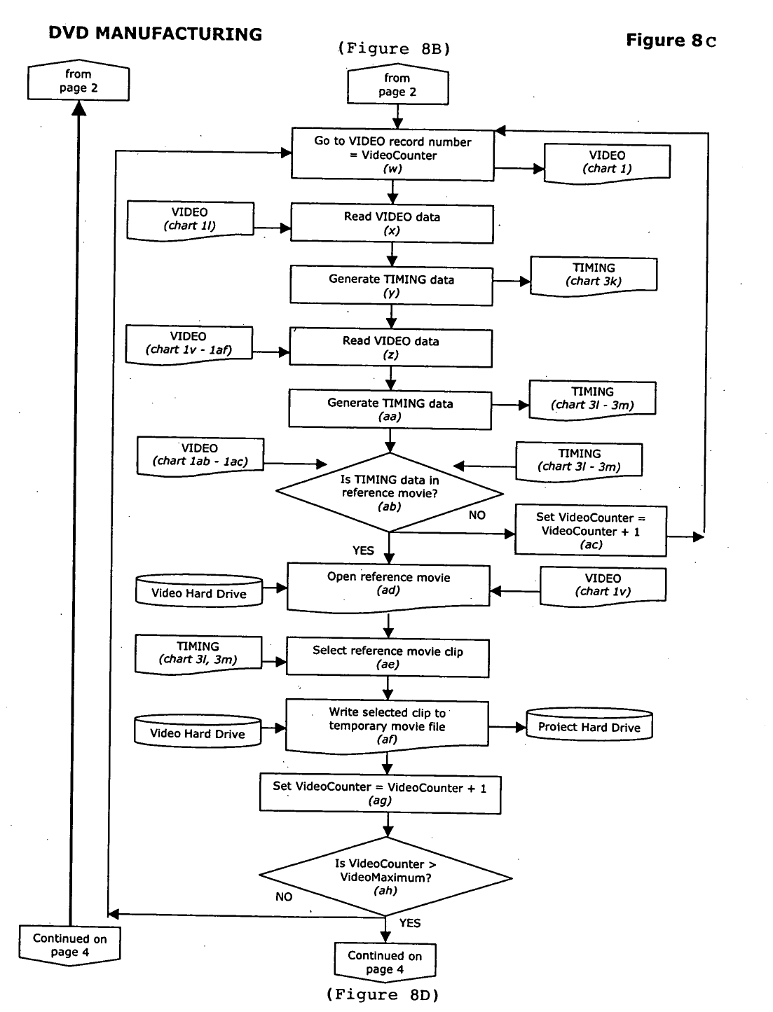

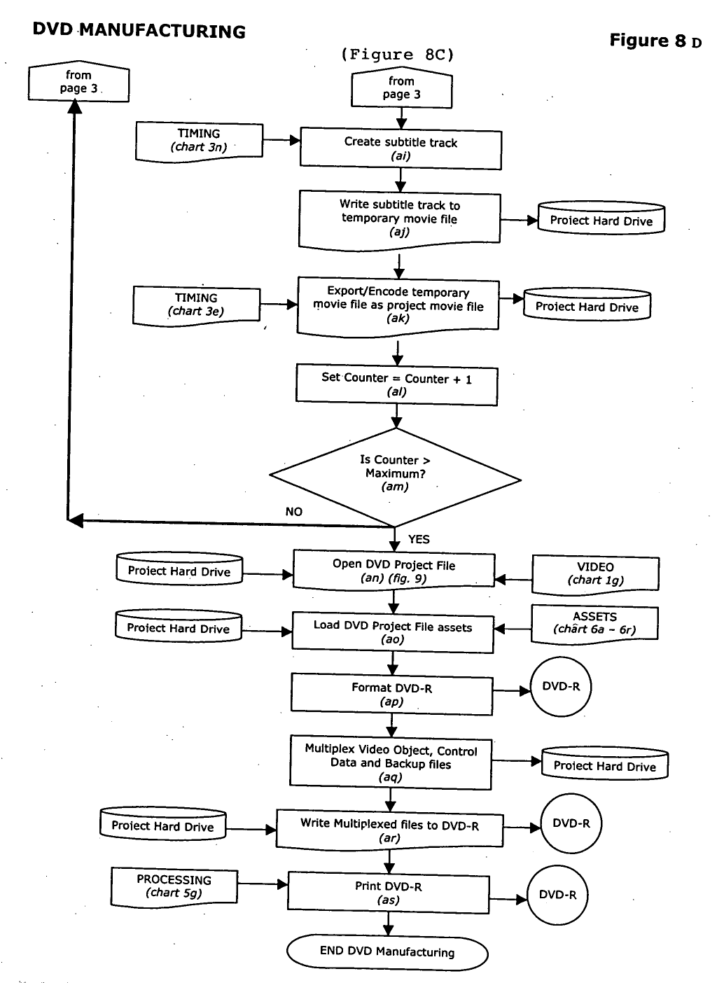

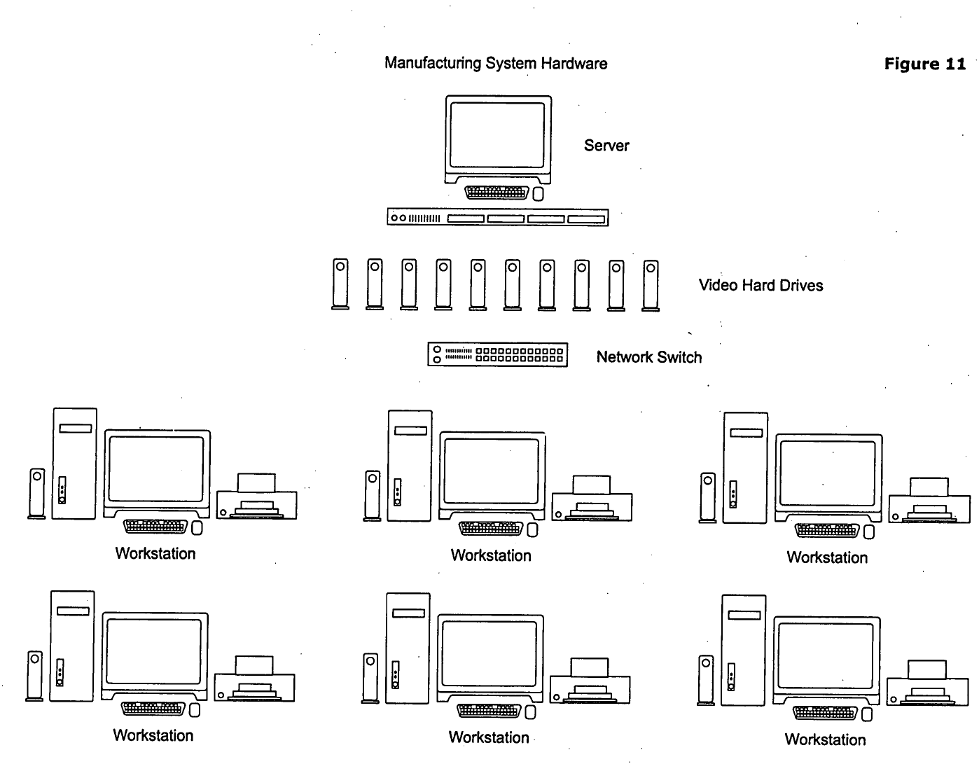

DVD Manufacturing: Setup. The DVD manufacturing process is also an important component of the invention. The process is controlled by a proprietary software program to access the necessary data, and control and execute all aspects of the manufacturing process, as described in FIGS. 8A-8D and referenced in Charts 1-6. Commercially available software may also be used in the manufacturing process, such as for the network server and operating system software, media player/editing software, graphics production software, database programming, DVD authoring software, audio and video codec software, and printing software. Typical hardware systems, as shown in FIG. 11, include a network server, VHDs, network switch, and multiple networked workstations, including hard drives, DVD read/write drives, and printers.

As shown in FIGS. 8A-8D, the PROCESSING database (Chart 5) controls the manufacturing process and manages the DVD orders with 1 record per order. In Steps 8(a)-8(b), PROCESSING data are used to generate data for personalizing the DVD to the order, such as on menus, subtitles and printing on the DVD itself (Chart 5, Items 5a-5i). Then based on the bib number, the related TIMING data are accessed to determine the number of timing points where that participant was detected and sorted by timing point numbers, in Steps 8(c)-8(e). In Step 8(f), the related VIDEO data for that participant are identified, namely the network path for the DVD project directory (Chart 1, Item 1g). The system also determines from the MESSAGES database (Chart 4, Item 4b), if a personal video message was recorded, in Step 8(g), and if so, writes the particular message's audio and video files, in Step 8(h), to the Project Hard Drive (“PHD”).

Next the DVD menus are personalized for each participant by adding text layers with PARTICIPANTS data (Chart 2, Item 2s) to pre-formatted graphics files from the ASSETS database (Chart 6, Item 6b, 6k) with the appropriate PROCESSING format (Chart 5, Item 5h) and then written to the PHD, in Steps 8(i)-8(n). The final setup steps involve setting the maximum number of timing points passed by the participant and setting a counter, in Steps 8(o)-8(p).

DVD Manufacturing: Movie Clips Acquisition. The MyMarathonDVD system automatically locates and copies the video clips that include the individual participant for the DVD order as that person is detected passing over the timing mat at each timing point on the course. Each reference movie stored in the system database is accessed, and the relevant video clip is retrieved as identified by the time position VIDEO TIME (XX) of the video time code that corresponds to that participant's CLOCK TIME at that timing point (see Synchronization above). The video clip data for the participant is read in a loop that is run for each timing point to retrieve the video clips to be assembled in a project movie file for the participant's DVD, as indicated in Steps 8(q)-8(am). The software processes the raw video clips from each reference movie by superimposing subtitle text tracks and compressing/encoding the individual's personal movie files in a DVD-Video standard format. The count of related VIDEO files, number of clips for the participant, and subtitles are also generated (Chart 3, Items 3f, 3j, 3n). The maximum number of video clips and a video counter are set, in Steps 8(u)-8(v). Then a sub loop is run for each video reference movie for the timing point to acquire the exact personal video clip, in Steps 8(w)-8(ah). There may be multiple personal video clips for each timing point; the number is calculated by the available clips for each participant (Chart 3, Item 3j).

In more detail, the ID (Chart 1, Item 1l) for the first VIDEO reference movie for the first timing point is read and inserted into the TIMING database (Chart 3, Item 3k), in Steps 8(x)-8(y). The VIDEO reference movie details, such as the clip source, the clip offset, and clip length, are read (Chart 1, Items 1v-1af) and used by the TIMING database to calculate the video clip's beginning and end points (Chart 3, Items 3l-3m), in Steps 8(z)-8(aa). If the video clip's beginning and end points are not contained within the reference movie (Chart 1, Items 1ab-1ac), then the video counter is incremented and the next video reference movie for that timing point is tested, in Steps 8(ab)-8(ac), as part of the sub loop of Steps 8(w)-8(ah). If the participant's video clip is contained within the reference movie, the sub loop continues and begins acquisition of the exact personal video clip, in Steps 8(ad)-8(ag). The video reference movie is opened and the video clip is selected based on the beginning and end points. The selected video clip is written to a temporary movie file, in Step 8(af). Then the video counter is incremented, in Step 8(ah), and the next video reference movie for that timing point is tested as part of the sub loop. If any additional video clips for that participant at that timing point are generated in the sub loop, they are appended to the temporary movie file.

After the maximum number of video clips for that timing point are tested and/or generated, the subtitle track is created, in Steps 8(ah)-8(ai). The subtitle is a text track that contains the participant's name, bib number, timing point, and chip time (Chart 3, Item 3n). Once the subtitle track is superimposed on all the acquired personal video clips in the personal movie file, the file is compressed/encoded in a DVD-Video standard format and written to the PHD, in Steps 8(aj)-8(ak), using a filename derived from Chart 3, Item 3e. Then the counter is incremented and tested and the next timing point is processed in the loop. After the maximum number of timing points are accessed and the personal movie files generated, the DVD project file can be used to assemble, write, and custom imprint the personalized DVD, in Steps 8(an)-8(as).

DVD Project File. The contents of the DVD project file are detailed in the ASSETS database (Chart 6). The DVD project file includes certain preprocessed standard asset files (Chart 6, Items 6a, 6c-6j, 6l). The preprocessed standard tracks (which appear unchanged on all DVDs) may include post-production audio, event highlights video, graphics, and menus, that make up the DVD-video program, which averages from 25 to 30 minutes in total running time. The DVD project file also includes personalized asset files (Chart 6, Item 6b, 6k, 6m, 6n-6r): custom menu files as previously described; the personal message track as previously described; and the generated personalized video tracks for each of the timing points as previously described.

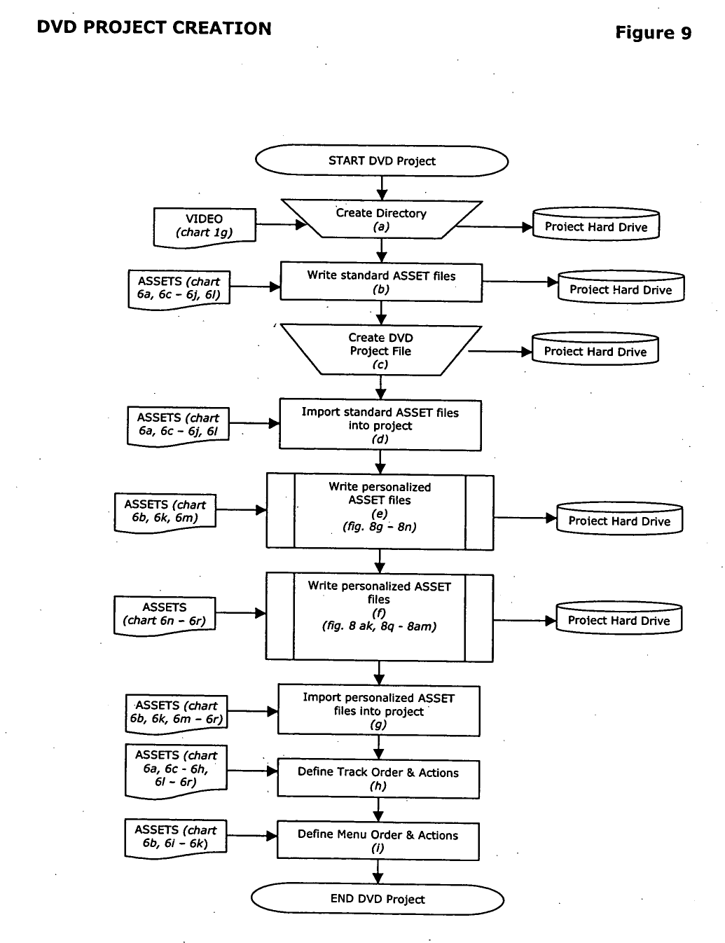

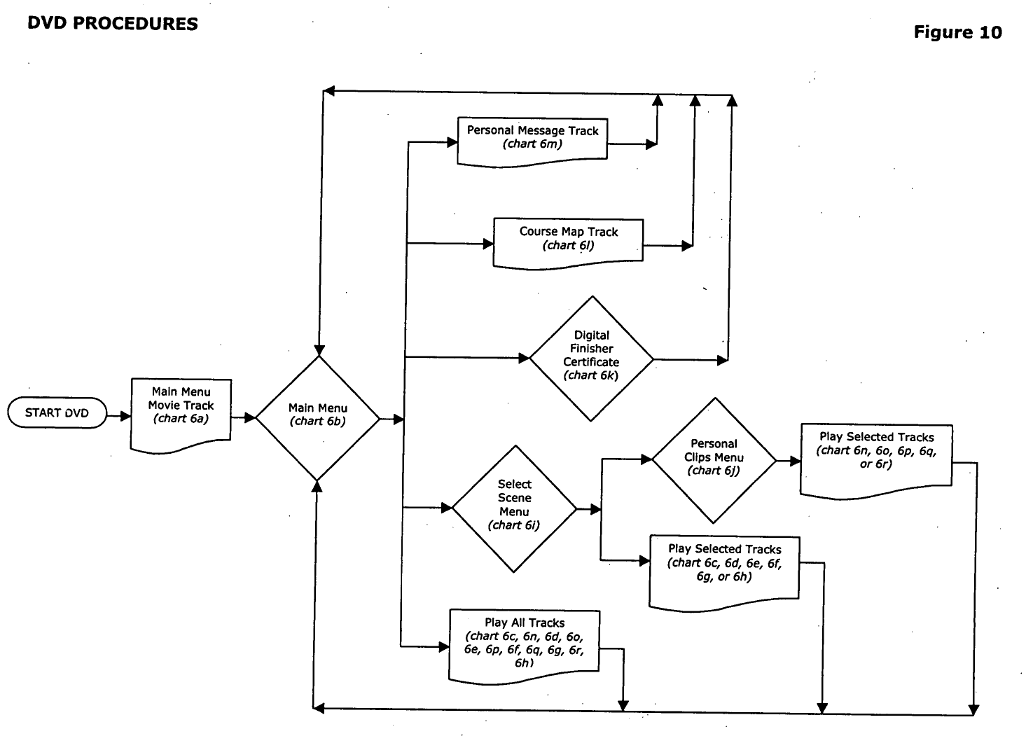

The creation of the DVD project file is illustrated in FIG. 9. It starts with the creation on the PHD of the project directory, in Step 9(a). Then the standard asset files are written to the PHD, in Step 9(b). Then the DVD project file is created on the PHD, in Step 9(c), followed by the importation of the standard asset files into the project file, in Step 9(d). The personalized ASSET files (video tracks), as previously described, are written to the PHD, in Steps 9(e)-9(f). After all the personalized asset files are written, they are imported into the DVD project file, in Step 9(g). Once the assets are assembled, the orders and actions for the DVD can be defined, in Steps 9(h)-9(i). Each DVD track corresponds with a precise temporal location within the program sequence. The DVD tracks are activated via standardized program, menu, and/or remote control buttons. The personalized video and graphics files are automatically inserted into tracks of a DVD project file. When the DVD project file has been completed, a DVD-R disc is formatted, the video object, control data and backup files are multiplexed, and the multiplexed files are then written and finished on the DVD-R disc, in Steps 8(ap)-8(ar). The finished DVD-video disc can be custom imprinted with the participant's name, bib number, and finish time along with the event title, logo and date, in Step 8(as). FIG. 10 is a diagram of a typical personalized DVD's content, structure and usage, and menu options.

In summary, the invention provides a system for automated production of personalized videos of individuals participating in large events. Through the unique time synchronization of the time at which a participant is detected passing through a station at the event to the video time code for the continuous video data recorded at each station of participants passing through, the system can automatically retrieve the video clips in which the participant appears, and assemble them in a personalized video. In particular, as a reference (first) participant passes through a station, the clock time at which that participant is detected as passing through the station is correlated to the video time at which that participant appears in the video as passing through the station, whereupon the detection times of all other participants passing through the station can be correlated to the video time at which those participants appear in the video as passing through the station. This synchronization method is important for the synchronized processing of video data from the digital video cameras at the event, in order to accurately and automatically identify the video clips in said data where an individual participant appears.

The principles of the present invention can be extended to a wide range of events and environments. The same principles applied to a long-distance race course can be applied to parties, weddings, graduations, conferences, conventions, etc. Since the synchronization method allows the video clips of individual participants to be accurately identified by time position in the video data recorded at any station, the invention can be adapted to any type of event without regard to the number of stations, the order in which they are traversed, whether or not all stations are visited, or are visited repeatedly or randomly. For example, the invention can be extended to commercial, governmental, school, or military security applications for monitoring the movements of individuals wearing ID badges passing through large facilities or over large areas.

Any type of suitable participant ID code detection devices and/or readers may be used, including electromagnetically transmitting chips or transmitters, magnetically readable cards, electronically readable cards or probes, optically readable barcode or graphic indicia, biometric readers (for fingerprint, voice, or iris), etc. Another device likely to be used in the future is a global positioning system (GPS) transponder which emits an ID signal that can be detected by a GPS detection system.

The video data from the cameras can be combined in the system database manually (by transportable memory devices), through wiring connections, Internet connections, wireless or microwave transmission, video phone transmission, etc.

Personalized videos may be recorded on any type of recordable media, including videotape, CD, DVD, flash memory, memory stick, memory card, or other recording media. The personal videos may be displayed on TVs, computer monitors, broadcast channels, video-on-demand systems, webcasts, mobile displays, video phones, etc.

It is to be understood that many modifications and variations may be devised given the above description of the principles of the invention. It is intended that all such modifications and variations be considered as within the spirit and scope of this invention, as defined in the following claims.

| 1 | Name | Type | Description |
|---|---|---|---|
| a | EventCode | Text | descriptor for current Event being |
| | | | processed (relational, required) |
| b | EventDate | Date | date for current Event being processed |
| c | EventDirectory | Text | directory for video hard drive/reference |
| | | | movie (unique, required) |
| d | FileExtension | Text | for accessing raw digital video files on |
| | | | video hard drive |
| e | FilePath | Text | network path for accessing server |
| f | MountVolume | Text | network directory for accessing server |
| g | ProjectPath | Text | network path for accessing manufacturing |
| | | | project directory |
| h | Description | Text | descriptor of particular reference |
| | | | movie/video hard drive |
| i | DestinationDrive | Text | indicator of copied video hard drive used |
| | | | for serving out reference movie |
| j | FieldDrive | Text | indicator of original video hard drive used |
| | | | for recording video at event |
| k | FieldKit | Text | indicator of original field kit used for |
| | | | recording video at event |
| l | ID | Number | indicator for particular reference |
| | | | movie/video clip (unique, relational, |
| | | | required) |
| m | Location | Text | descriptor of camera location for video hard |
| | | | drive |
| n | TimingNo | Number | sequential reference to particular timing |
| | | | point (relational, required) - e.g., 1 is |
| | | | TimingNo for Start, etc. |
| o | TimingPoint | Text | descriptor of particular timing point - e.g. |
| | | | Start, 10k, etc. |
| p | FileName | Calculation | base file name for raw digital video files on |
| | | (Text) | video hard drive |
| q | FileNameDate | Calculation | date converted to text for accessing raw |
| | | (Text) | digital video files on video hard drive |
| r | LogCount | Calculation | count of log entries on original video hard |
| | | (Number) | drive |
| s | ClipNoEnd | Number | indicator of last raw digital video file used |
| | | | to compile reference movie |
| t | ClipNoStart | Number | indicator of first raw digital video file used |
| | | | to compile reference movie |
| u | Notes | Text | notes regarding particular reference movie |
| v | ClipSource | Calculation | complete network path for accessing |
| | | (Text) | reference movie: EventDirectory + CompiledMovie |
| w | CompiledMovie | Text | file name of compiled reference movie |
| x | CompiledMovieLength | Calculation | length of reference movie |
| | | (Time) | |
| y | CameraTime | Time | the digital time code of the reference movie |
| | | | when the first timed participant hits the |
| | | | timing mat |
| z | ClockTime* | Time | the first timed participant's |
| | | | TIMING: ClockTime for that timing point |
| aa | Differential | Calculation | for synchronizing video with official timing |
| | | (Number) | data: CameraTime − ClockTime |
| ab | ClipMovieStartTime | Calculation | number of seconds of the ClockTime − CameraTime |
| | | (Number) | |
| ac | ClipMovieEndTime | Calculation | number of seconds of the |
| | | (Number) | ClipMovieStartTime + CompiledMovieLength |
| ad | ClipLength | Time | length of video clip to be extracted from |
| | | | the reference movie |
| ae | ClipOffset | Number | number of seconds in the reference movie |
| | | | before the participant hits the timing mat |
| af | ClipLengthCalc | Calculation | number of seconds in ClipLength |
| | | (Number) | |

*official event data
Time data is always in HH:MM:SS format

| 2 | Name | Type | Description |
|---|---|---|---|
| a | EventCode | Text | descriptor for current Event being |
| | | | processed (relational, required) |
| b | BibNo* | Text | bib number of participant (unique, relational, required) |
| c | FirstName* | Text | first name of participant |
| d | LastName* | Text | last name of participant |
| e | Age* | Number | age of participant |
| f | Gender* | Text | gender of participant |
| g | Division* | Text | event division of participant |
| h | City* | Text | city of participant |
| i | State* | Text | state of participant |
| j | Country* | Text | country of participant |
| k | PlaceOverall* | Text | event placement overall of participant |
| l | PlaceGender* | Text | event placement by gender of participant |
| m | PlaceDivision* | Text | event placement by division of participant |
| n | FinishClockTime* | Time | clock time of participant at Finish |
| o | FinishChipTime* | Time | chip time of participant at Finish |
| p | StartChipTime* | Time | chip time of participant at Start |
| q | Countryprint | Calculation | country or city/state of participant |
| | | (Text) | formatted for use on DVD menu |
| r | DNF | Calculation | boolean indicator of finisher status based |
| | | (Number) | on FinishClockTime |
| s | MyResults | Calculation | digital finisher certificate data including |
| | | (Text) | official timing data, placements, division, |
| | | | age, gender, etc. of participant formatted for use |
| | | | on DVD menu |
| t | TimingCount | Calculation | count of participant's timing points with |
| | | (Number) | TIMING: ChipTime |

*official event data
Time data is always in HH:MM:SS format

| 3 | Name | Type | Description |
|---|---|---|---|
| a | EventCode | Text | descriptor for current event being processed |
| | | | (relational, required) |
| b | BibNo* | Text | bib number of participant (relational, required) |
| c | ChipTime* | Time | chip time of participant for particular timing point |
| d | TimingNo | Number | sequential reference to particular timing point |
| | | | (relational, required, also used in VIDEO) - e.g., 1 is |
| | | | TimingNo for Start, etc. |
| e | TimingPoint | Text | descriptor of particular timing point (required, also |
| | | | used in VIDEO) - e.g. Start, 10k, etc. |
| f | ClipCount | Calculation | count of video files VIDEO: ID associated with |
| | | (Number) | particular timing point |
| g | ClockTime | Calculation | calculation of ChipTime + PARTICIPANTS: |
| | | (Time) | StartChipTime of participant for |
| | | | particular timing point |
| h | NoData | Calculation | boolean indicator of missing timing data based on |
| | | (Number) | ChipTime |
| i | Place | Calculation | calculated actual order of participant passing |
| | | (Number) | particular timing point based on ClockTime |
| j | Clips | Calculation | count of available video clips for participant for |
| | | (Number) | particular timing point |
| k | ID | Number | VIDEO: ID for particular reference movie/video clip |
| | | | (relational, required) |
| l | ClipEnd | Calculation | time in seconds of VIDEO: ClipStart + VIDEO: |
| | | (Number) | ClipLength for particular reference |
| | | | movie/video clip |
| m | ClipStart | Calculation | time in seconds of ClockTime + VIDEO: |
| | | (Number) | ClipsDifferential − VIDEO: ClipOffset for |
| | | | particular reference movie/video clip |
| n | Subtitle | Calculation | Data formatted to appear in video subtitles; BibNo & |
| | | (Text) | PROCESSING: Name & TimingPoint & ChipTime |
| o | OrderID | Number | PROCESSING: ID of current order being processed |
| | | | (relational, required) |

*official event data
Time data is always in HH:MM:SS format

| 4 | Name | Type | Description |
|---|---|---|---|
| a | BibNo* | Text | bib number of participant (unique, |
| | | | relational, required) |
| b | MessageCode | Number | ID for message (unique, required) |
| c | MessageDate | Date | date message was recorded (required) |
| d | MessageNo | Number | file number of message's raw |
| | | | digital video file (required) |
| e | MessageNote | Text | notation regarding message |
| f | OrderID | Number | PROCESSING: ID of DVD order |
| | | | (relational, required) |
| g | ClipFileName | Calculation | file name for raw digital video file |
| | | (Text) | on video hard drive (required) |

*official event data

| 5 | Name | Type | Description |
|---|---|---|---|
| a | OrderID | Number | DVD order ID (unique, relational, |
| | | | required) |
| b | EventCode | Text | descriptor for current Event being |
| | | | processed (relational, required) |
| c | BibNo* | Text | bib number of participant (relational, |
| | | | required) |
| d | FirstName | Text | first name of participant to be featured |
| | | | on DVD (required) |
| e | LastName | Text | last name of participant to be featured |
| | | | on DVD (required) |
| f | Quantity | Number | quantity of DVDs ordered |
| g | DVDName | Calculation | participant's name formatted to print on |
| | | (Text) | DVD |
| h | MenuName | Calculation | participant's data formatted to appear on |
| | | (Text) | DVD menu |
| i | Name | Calculation | Participant's name formatted for |
| | | (Text) | subtitles on DVD |
| k | TimingCount | Calculation | count of participant's |
| | | (Number) | related timing data: |
| | | | TIMING: TimingNo; indicates the |
| | | | number of Timing Points for that |
| | | | participant |

*official event data

| 6 | Name | Type | Description |
|---|---|---|---|
| a | MainMenuMovie | track | contains animated video & graphics montage |
| | | | with audio (startup action) |
| b | MainMenu | menu | interface for DVD top menu, contains graphic |
| | | | with buttons for DVD user-controlled actions, |
| | | | personalized for participant |
| c | StartSequence | track | contains standard video & audio for program |
| | | | introduction and event Start |
| d | 10kSequence† | track | contains standard video & audio for event 10k |
| e | HalfSequence† | track | contains standard video & audio for event Half |
| f | 30kSequence† | track | contains standard video & audio for event 30k |
| g | FinishSequence | track | contains standard video & audio for event Finish |
| h | PostEventSequence | track | contains standard video & audio for program |
| | | | conclusion and post event |
| i | SelectScene | menu | interface for Dvd secondary menu, contains |
| | | | graphic with buttons for DVD user-controlled actions |
| j | PersonalClips | menu | interface for Dvd secondary menu, contains |
| | | | graphic with buttons for DVD user-controlled actions |
| k | DigitalFinisherCertificate | menu | graphic display of official event data, |
| | | | personalized for participant |
| l | CourseMap | track | contains animated video & graphics with audio |
| | | | of course map |
| m | PersonalMessage | track | contains video & audio of particpant's personal |
| | | | message (optional) |
| n | Start | track | contains video & audio clip of Start with |
| | | | personalized subtitle based on participant's |
| | | | Start time and event data |
| o | 10k† | track | contains video & audio clip of 10k with |
| | | | personalized subtitle based on participant's |
| | | | 10k time and event data |
| p | Half† | track | contains video & audio clip of Half with |
| | | | personalized subtitle based on participant's |
| | | | Half time and event data |
| q | 30k† | track | contains video & audio clip of 30k with |
| | | | personalized subtitle based on participant's |
| | | | 30k time and event data |
| r | Finish | track | contains video & audio clip of Finish with |
| | | | personalized subtitle based on participant's |
| | | | Finish time and event data |

†these are the most common timing/video acquisition points however timing points vary based on event and may include additional points such as 15k, 20 miles, 40k, etc.

1. A system for automated production of personalized videos for individuals participating in a large event comprising:
(a) a plurality of participant ID markers each borne or worn by a respective one of a corresponding plurality of participants in a large event for uniquely identifying each participant in the large event;
(b) a plurality of stations distributed in a physical space encompassed by the large event, wherein each station has a detector for detecting the presence of ID markers on participants passing through the station and providing detection time data corresponding to the detection time at which each participant is detected as passing through the station, and at least one digital video camera positioned at the station for continuously recording video of participants passing through the station, wherein the video is recorded as data indexed with video time denoted by a sequential video time code;
(c) a system database for storing the detection time data for the participants detected passing through the stations at the large event, and the video data recorded by the digital video cameras positioned at the stations at the large event;
(d) a time synchronization module operable with said system database for correlating the detection time for each participant passing through each station with video clips corresponding to the video time of the video taken by each digital video camera corresponding to that participant passing through that station; and
(e) a video production module operable with said system database and said time synchronization module and having means for: (i) identifying the video clips of an individual participant passing through the stations at the large event based upon the detection times of that participant's marker ID at the stations, and (ii) assembling the video clips for the individual participant in a personalized video.

2. A system according to claim 1, wherein said time synchronization module includes means for detecting the detection time of a reference participant passing through a station, means for identifying the video time at which that participant appears in the video as passing through the station, and means for calculating the differential between the detection time and the video time for the reference participant, and means for applying the differential to correlate the detection times of other participants passing through the station with the video times at which those participants appear in the video as passing through the station.

3. A system according to claim 2, wherein said reference participant is the first participant at the large event to pass through the station and be detected by the detector.

4. A system according to claim 2, wherein said reference participant is used to synchronize detection time to video time for all the stations at the large event.

5. A system according to claim 1, wherein said personalized video is recorded on a DVD storage and playback medium.

6. A system according to claim 1, wherein said personalized video is recorded on a recording medium selected from the group consisting of: CD, DVD, flash memory, memory stick, and memory card.

7. A system according to claim 1, wherein said personalized video is recorded in a format to be displayed on a TV.

8. A system according to claim 1, wherein said personalized video is recorded in a format to be displayed on a display selected from the group consisting of: TV, computer monitor, broadcast channel, video-on-demand system, webcast, mobile display, or video phone.

9. A system according to claim 1, wherein said personalized video is assembled with video clips from video data recorded at stations on a long-distance race course.

10. A system according to claim 1, wherein said personalized video is assembled with video clips from video data recorded at a large event selected from the group consisting of: long-distance race, party, wedding, graduation, and conference.

11. A system according to claim 1, wherein said personalized video is assembled with video clips from video data recorded at stations passed by participants at random.

12. A system according to claim 1, wherein said personalized video is assembled with video clips from video data recorded at stations defined in a large facility or over a large area.

13. A system according to claim 1, wherein said participant ID markers are ID markers selected from the group consisting of: electromagnetically transmitting chips, electromagnetically transmitting transmitters, magnetically readable cards, electronically readable cards, electronically readable probes, optically readable barcode, optically readable graphic indicia, biometric markers, and GPS transponders.

14. A system according to claim 1, wherein said video data from the digital video cameras are transmitted into the system database by a transmission method selected from the group consisting of: manual transmission, wiring connection, Internet connection, wireless transmission, microwave transmission, and video phone transmission.

15. A system according to claim 1, wherein said video production module includes means for combining standard event video, audio, graphics, and other assets into the personalized video.

16. A system according to claim 15, wherein said video production module pre-records the standard event assets on predetermined tracks of a recording disc, and records the personalized video clips on other predetermined tracks of the recording disc.

17. A system according to claim 1, wherein said video production module includes means for combining personalized messages recorded on video data into the personalized video.

18. A method for automated production of personalized videos for individuals participating in a large event comprising:
(a) providing participant ID markers each to be borne or worn by a respective one of a corresponding plurality of participants in a large event for uniquely identifying each participant in the large event;
(b) providing detection time data of the times at which the ID markers on participants are detected at a station at the large event;
(c) continuously recording video data of participants passing through the station, wherein the video is recorded as video data indexed with video time denoted by a sequential video time code;
(d) detecting the detection time of a reference participant passing through the station, identifying the video time at which the reference participant appears in the video passing through the station, and calculating the differential between detection time and the video time for the reference participant;
(e) applying the calculated differential to correlate the detection times with the video times of the other participants passing through the station; and
(f) identifying the video clip of any individual participant passing through the station based upon the detection time of that participant's marker ID correlated to the video time of the video data using the calculated differential of the reference participant.

19. A method according to claim 18, wherein said reference participant is the first participant at the large event to pass through the station and be detected by the detector.

20. A method according to claim 18, wherein said reference participant is used to synchronize detection time to video time for all the stations at the large event.
